(19) United States
(12) Patent Application Publication
(10) Pub. No.: US 2004/0069059 A1
(43) Pub. Date: Apr. 15, 2004

(54) Method and an apparatus for performing a measurement of a continuous sheet

(75) Inventor: John Shakespeare, Siuro (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Metso Paper Automation Oy, Tampere (FI)

(21) Appl. No.: 10/270,890

(22) Filed: Oct. 15, 2002

(51) Int. Cl. G01L 5/04

(52) U.S. Cl. 73/159

(57) ABSTRACT

The invention relates to a method and an arrangement for performing a measurement of a continuous sheet. At least one measurement of the sheet is performed by at least one sensor, an estimate of the sampling function of the sensor being available. The solution comprises means for performing deconvolution using at least one iteration of an algorithm which corresponds to the deconvolution, and the means are arranged to perform the deconvolution of the at least one measurement with the estimate of sampling function. The solution can be applied in a CD-measurement of a continuous sheet. The solution can also be applied in controlling production of a continuous sheet.

### FIELD OF THE INVENTION

The invention relates to a method for performing a measurement of a continuous sheet.

### BACKGROUND

In manufacturing or processing of a continuous sheet, the quality of a sheet is usually measured across the web by sensors performing cross-directional (CD) measurements. Typical variables measured in CD measurements are moisture content, caliper and basis weight. The spatial distribution of numerous sheet properties are of critical importance, and it is advantageous to know them with high spatial resolution as well as with high accuracy and precision.

Each sensor of the CD measurement is non-ideal in a number of ways. Imperfections such as linearity and inter-instrument agreement are addressed by various calibration techniques usually employing physical models of the measurement and calibration data. Effects which cannot be modeled a priori, including multivariate correlations and noise, are often treated using statistical filtering methods. Usually, several techniques in combination are required to improve accuracy and precision of measurement.

The used techniques, however, cannot effectively cancel all imperfections. In a sensor which is to produce a representation of the spatial distribution of a property, other imperfections arise. In particular, the sensor samples the property over a finite interval, so that instead of a true value of the property an average of the property is measured. Moreover, the measurement can be even more distorted by the physical interaction of the sensing mechanism with the finite interval, which may not be uniform. Because of that the measurement result is an average, which is weighted with unknown weights.

### SUMMARY

It is therefore an object of the present invention to provide an improved method and an improved arrangement implementing the method. This is achieved with a method for performing a measurement of a continuous sheet. The method comprises: performing at least one measurement of the sheet in which an estimate of the sampling function of the measurement is available; performing the deconvolution of the at least one measurement with the estimate of the sampling function using at least one iteration of an algorithm which corresponds to the deconvolution.

The invention also relates to an arrangement for performing a measurement of a continuous sheet, the arrangement comprising: at least one sensor for performing at least one measurement of the sheet, an estimate of the sampling function of the sensor being available; means for performing deconvolution using at least one iteration of an algorithm which corresponds to the deconvolution, and the means are arranged to perform the deconvolution of the at least one measurement with the estimate of the sampling function

Preferred embodiments of the invention are disclosed in the dependent claims.

The invention is based on deconvolution of the measurement results which is performed with a sampling function for a sensor. An estimate of the sampling function is known because the sampling function can be measured, simulated or derived theoretically beforehand or afterwards. The method of the invention is to perform an iterative refinement of the sensor measurement to approximate the true property. In particular, the present invention performs one or more iterations of an algorithm which converges to the deconvoluted measurement.

The method and arrangement of the invention provide various advantages. The present invention eliminates at least partly imperfections of sensors and enhances thus resolution of measurements.

### BRIEF DESCRIPTION OF THE DRAWINGS

In the following, the invention will be described with reference to preferred embodiments and to the accompanying drawings, in which

FIG. 1A shows measurement of a sheet,

FIG. 1B shows sampling function,

FIG. 2 shows sampling function when the object to be measured is moving with a certain velocity,

FIG. 3 shows an example of the frequency response of a sensor,

FIG. 4 shows a case where one sensor scans over an object to be measured,

FIG. 5 shows a case where an array of sensors scans an the object to be measured,

FIG. 6 shows CD measurements in the control of the paper or cardboard production, and

FIG. 7 shows a paper machine.

### DETAILED DESCRIPTION

The presented solution is well-suited for use in process industry such as sheet, film or web processes in paper, plastic and fabric industries, the invention not being, however, restricted to them.

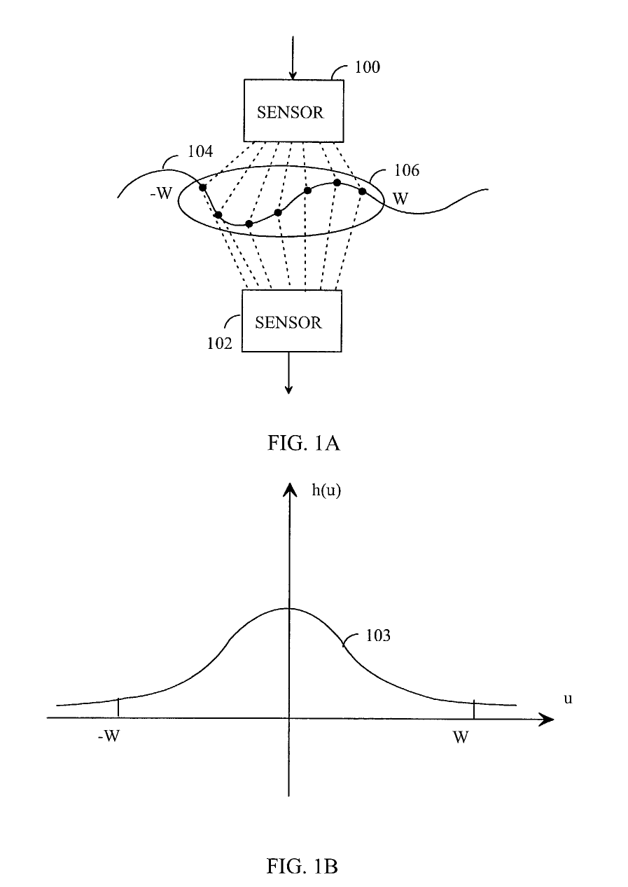

Let us now study the measurement principle of a sensor with reference to FIG. 1. The measurement is frequently performed by means of a sensor comprising a transmitter sensor 100 and a receiver sensor 102. Basis weight, for instance, can be measured with β radiation in such a way that the transmitter sensor 100 transmits β radiation to the paper web being the object of measurement, the receiver sensor 102 on the other side of the paper web measuring this β radiation. In the same way, the moisture content of the paper web can be measured with two antennas functioning as sensors in such a way that the antenna 100 of a microwave transmitter transmits microwave radiation to the paper web being the object of measurement, the receiver antenna 102 on the other side of the paper web receiving and measuring this microwave radiation. However, the sensor can in general consist of one part only, in which case the transmitter part and the receiver part are together and the sensor comprises a receiver part only. Other measurement principles may employ mechanical stimulus or contact, and the geometries of optical, mechanical or electromagnetic devices may vary according to the relevant art. The transmitter sensor 100 transmits a measurement signal towards an object 104 to be measured, and the receiver sensor 102 receives a measurement signal which has been in interaction with the object 104 to be measured in the detection area −w . . . +w. The line denoting the object 104 to measured also indicates the values of the property as measured at different points of the object 104 to be measured. Waving means variation of the property to be measured as a function of the location in the object to be measured. In the solution presented, it is specifically the property of the object to be measured that is measured, and sensors are not used to form a picture of the object to be measured. Since, in the object 104 to be measured, the measurement signal has been in interaction not with one point but with the physical surface or the volume, which are expressed in a discrete manner with several points 106 in FIG. 1A, the property to as measured f(x) is an integral of the sampling function h(u) according to the measurement principles of the sensor, and of the real property g(x).

FIG. 1B shows a sampling function h(u) 103 of a sensor according to the measurement principle of the sensor. The vertical axis shows the value of the sampling function h(u) and the horizontal axis shows the distance u from the zero point of the measurement, the middle point of the measurement area being usually selected as the zero point. The values of the sampling function h(u) are defined in the detection area −w<u<+w of the sensor. The response of the sensor according to the sampling function is weaker in the edges of the measurement area compared with the middle of the measurement area. The solution presented is not, however, restricted to a certain form or distribution of the sampling function h(u) but can be any measured, simulated or theoretically derived sampling function. The values f(x) of the measured property may be represented as:

$$f ( x ) = {\int }_{- w}^{+ w} g ( x + u ) h ( u ) ⅆ u \qquad ( 1 a )$$

where * is convolution operator, g or g(x) is the true value of the property to be measured at position x, h or h(u) is the sampling function corresponding to the sensor's measurement principle and is nonzero only in the range −w<u<+w, and f(x) is the measured value. More generally, the range for which h(u) is non-zero need not be symmetric around zero, and can be −w₁<u<w₂, but for convenience and without loss of generality, it will be treated as symmetric below. The variable u measures distance and its unit is meter.

In reality, the sampling function h may not be known, and needs not be known, in detail, but it is sufficient to know some kind of estimate corresponding to reality about the sampling function h. In the present application, an estimate of the sampling function and an exact, usually only theoretically definable sampling function are not distinguished from each other, because the present solution can utilize an accurate or an approximated sampling function. Due to construction or operation of the sensor, it is possible for the sampling function to depend on position of the sensor with relation to the object to be measured. In this case, (1a) becomes:

$$f ( x ) = {\int }_{- w}^{+ w} g ( x + u ) {h}_{x} ( u ) ⅆ u \qquad ( 1 b )$$

Equations (1a) and (1b) and FIG. 1A and FIG. 1B are for a sensor which is essentially stationary with respect to the sample to be measured. This is the case, for instance, when the measurement interval in time is short compared to the dimensions of the sampling interval ±w divided by the relative velocity. This arises, for instance when measurements are made optically with stroboscopic illumination. The duration of the flash is short enough that relative movement between sensor and sample is negligible. If, however, the measurement interval is longer than this, then the effective sampling function will depend on the velocity.

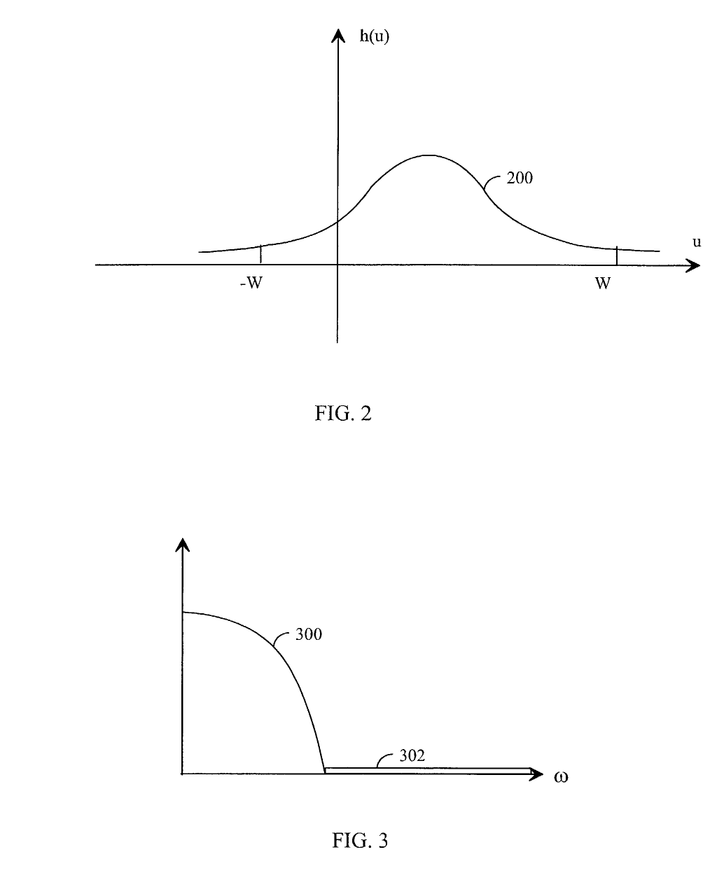

When the object to be measured is moving at a certain velocity relative to the sensor, the sampling function h(u) 200 is displaced compared with FIG. 1B relative to the zero point in accordance with FIG. 2. The vertical axis shows the value of the sampling function, and the horizontal axis shows the distance from the zero point of the measurement. Thus, the property of Formula (1a) to be measured fᵥ(x) can be presented as follows:

$${f}_{v} ( x ) = {\int }_{- {w}_{v}}^{+ {w}_{v}} g ( x + u ) {h}_{v} ( u ) ⅆ u \qquad ( 1 c )$$

where hᵥ(u) is the sampling function, which takes into account the movement of the object to be measured relative to the sensor. Taking into account in the sampling function hᵥ(u) the movement between the sensor and the object to be measured, deconvolution allows the displaced curve 200 to be returned in a way to a location corresponding to the curve 100 of FIG. 1B and removes the interfering effect of the movement from the measurement. For a scanning sensor, the sampling function hᵥ(u) may depend on the direction of travel as well as the speed of the scan. In this case, the apparent sensor measurement fᵥ(x) can differ depending on the direction of the scan, for a given property g(x). For a scanning sensor, dependence of the sampling function on scanning speed can be dependent on or independent of its dependence on position.

Note that for simplicity equations (1a), (1b), and (1c) are stated for a unidimensional measurement, but that the measurement principle applied to sheet properties usually involves a two-dimensional or three-dimensional representation. In the general case:

$$f ( x ) = {∮}_{W} g ( x + u ) h ( u ) ⅆ u \qquad ( 2 a )$$

where f(x), g(x), and h(u) are the same functions as before, but defined on vector arguments, and the integration is taken over the at least two dimensional region W on which h(u) is nonzero. For a sampling function which is position dependent, the multidimensional equivalent of (1b) is:

$$f ( x ) = {∮}_{W} g ( x + u ) {h}_{x} ( u ) ⅆ u \qquad ( 2 b )$$

where W is a region supporting all sampling functions. If there is significant relative movement during each measurement, then (2a) becomes similar to (1 c):

$${f}_{v} ( x ) = {∮}_{W} g ( x + u ) {h}_{v} ( u ) ⅆ u \qquad ( 2 c )$$

Similarly, equations (1a) to (2c) have been stated for sensors which provide scalar measurements, but can obviously be generalized to sensors which give multi-valued scalar or vector measurements.

For a given relative velocity between the sensor and the sample, equations (1c) and (2c) are essentially the same as (1a) and (2a). The sampling function and integration region differ, however, in their dimension. For clarity, we continue for the one-dimensional case of equation (1a), without loss of generality.

The convolution (1a) can also be expressed in an integral transform space, by means of a suitable integral transformation. Suitable transformations include, but are not restricted to Fourier, Z-, Hartley, Laplace, Hilbert, Wavelet, Wigner-Ville, Cosine and Sine transforms and wavelet transforms, which can be implemented using analog or digital methods. Mathematical expressions for Laplace-, Fourier-, and Z-transforms are as follows:

$$\begin{matrix}L \{ f ( t ) \} = F ( s ) = {\int }_{0}^{∞} {ⅇ}^{- s t} f ( t ) ⅆ t , \\ {L}^{- 1} \{ F ( s ) \} = f ( t ) = {\int }_{0}^{∞} {ⅇ}^{s t} F ( s ) ⅆ s , \\ F \{ f ( t ) \} = F ( j ω ) \frac{1}{\sqrt{2 π}} {\int }_{- ∞}^{∞} {ⅇ}^{- j ω t} f ( t ) ⅆ t , \\ {F}^{- 1} \{ F ( j ω ) \} = f ( t ) = \frac{1}{\sqrt{2 π}} {\int }_{- ∞}^{∞} {ⅇ}^{j ω} F ( j ω ) ⅆ ω , \\ Z \{ f ( n ) \} = F ( z ) = {\sum }_{n = 0}^{∞} f ( n ) {z}^{- n} , \\ {Z}^{- 1} \{ F ( z ) \} = f ( n ) = \frac{1}{2 π j} {∮}_{C} F ( z ) {z}^{n - 1} ⅆ z ,\end{matrix}$$

where L is a Laplace transform, L⁻¹ is an inverse Laplace transform, F is a Fourier transform, F⁻¹ is an inverse Fourier transform, Z is a Z transform, Z⁻¹ is an inverse Z transform, F(s) is the Laplace transform of f(t), F(jω) is the Fourier transform of f(t), F(z) is the Z transform of f(t), j is an imaginary unit for which j=\sqrt{−1} holds true, s is an s-variable of the complex s-space of the Laplace transform, ω is a variable of the frequency space of the Fourier transform, z is a variable of the Z transform, t is a time variable, n is the sample number in discrete time domain, C is the closed path along which the integration takes place.

Neglecting a multiplicative factor which may arise in some transformations, (1a) becomes:

F(p)=G(p)H(p) (3)

where p denotes a value in the parameter space of the transformation, and F(p), G(p), and H(p) are the respective transformations of f(x), g(x), and h(u). Superficially, the transform G(p) of the true spatial distribution g(x) can be obtained by inversion of (3):

G(p)=(H(p))⁻¹F(p) (4)

While equations (3) and (4) apply directly to the case (1a), and to any particular instance of (1c), multidimensional versions may be written for the case (2a), or any particular instance of (2c). Use of an integral transform with a suitably varying kernel allows generalization to cases (1b) and (2b).

If the calculation in equation (4) were directly possible, then transformation of G(p) back to spatial domain would give the true spatial distribution g(x). In practice, the calculation in equation (4) is not possible, or is only possible for some values of the parameter p, since H(p) contains zeros for some parameter values. For instance, in the Fourier domain representation, H(jω) will have zeros corresponding to some frequencies ω, for which the measurement H(jω) will also be zero and those frequencies will be indeterminate in the calculation in (4), and G(jω) cannot be estimated for those frequencies. Thus, there can be many plausible functions g(x) which satisfy (1), consistent with the observed measurements f(x) and the sampling function h(u), but they cannot be determined directly from (4). Moreover, even for those parameter values for which H(p) is nonzero, the value of H(p) might be small, so that the computation in (4) amplifies noise or uncertainty in the measurement F(p). Similarly, some values of H(p) might be relatively uncertain, especially small values, so that the computation in (4) might be dominated by the uncertainty in some values of H(p).

For these reasons, for example, attempts to estimate the true spatial distribution g(x) from the measured spatial distribution f(x) are not very successful in cross-machine measurements.

The true spatial distribution g(x) can, however, be estimated using iterative algorithms. In iterative methods, the measurement result f is compared with the convolution result g*h. The comparison can be performed for instance by forming a difference f−g*h, or by calculating the ratio f/(g*h) of the measurement result f and the convolution result. After this, the value of g is changed on the basis of the comparison result. The comparison result can also be weighted with a weighting coefficient λ by multiplying the difference or ratio by the weighting coefficient λ, which is a real number between 0 . . . 1, for example as follows: λ(f−g*h) or λf/(g*h). The more accurate an estimate of the sampling function h is available, the better the iterative methods decrease the effect of the sensor in the measurement.

Algorithms which can be employed for these non-imaging purposes are for example Van Clittert's method and the Richardson-Lucy method. A number of refinements can be incorporated in these algorithms, such as enforcement of various constraints, or non-linear instead of linear iteration. If sufficient a priori knowledge is available, then techniques such as Fourier continuation or spectral extrapolation may also be incorporated in the method.

In Van Clittert's method, the enhancement iteration producing approximation k+1 from approximation k is:

$${g}^{( k + 1 )} ( x ) = {g}^{k} ( x ) + λ ( f ( x ) - {∮}_{W} {g}^{k} ( x + u ) h ( u ) ⅆ u ) \qquad ( 5 )$$

where λ is a relaxation parameter for the calculation. The sensor measurement is usually taken as the initial approximation, g⁰(x)=f(x).

In the Richardson-Lucy method, the enhancement iteration producing approximation k+1 from approximation k is

$${g}^{( k + 1 )} ( x ) = {g}^{k} ( x ) ( 1 + λ ( \frac{f ( x )}{{∮}_{W} {g}^{k} ( x + u ) h ( u ) ⅆ u} - 1 ) ) \qquad ( 6 )$$

where λ is a weight. The sensor measurement is usually taken as the initial approximation, g⁰(x)=f(x). The forms given here for Van Clittert's method and for the Richardson-Lucy method are for measurement in multiple dimensions, such as in forming a 2-dimensional image of a measured property. Replacing the vector coordinates x and u with scalar coordinates x and u, and performing a univariate integral instead of the region integral, yields the equivalent form for measuring a property along a line.

In both cases, the weight is a relaxation parameter λ which may be a constant greater than zero and less than unity. However, improved convergence with reduced sensitivity to noise is obtained when the value of λ is adaptively controlled and depends on the value of the approximation g^{k}(x) being refined:

λ(x)=φ(g^{k}(x)) (7a)

For a measurement which is zero-based, or approximately zero-based, it is advantageous for the function φ(q) to have properties φ(0)=0 and φ(qₘₐₓ)=1, where qₘₐₓ is the largest value in g^{k}(x). A zero-based measurement is a measurement of a property which cannot be negative, and whose minimum possible value is zero. Mass, density, and area are obviously zero-based measurements. A zero-mean measurement is a measurement of a property whose mean value over the measurement region is zero, either intrinsically or by definition, so that it is expected to have both positive and negative values, which cancel in summation. A measurement of variation in a property around its mean value is obviously a zero-mean measurement. For a measurement which is zero-mean, or approximately zero-mean, it is advantageous for φ(q) to have properties φ(0)=0 and φ(qₘₐₓ)=1, where qₘₐₓ is the largest value in |g^{k}(x)|. In this case, the relaxation parameter depends on the absolute value of the estimate:

λ(x)=φ(|g^{k}(x)|) (7b)

Typically, the relation used for φ(q) is monotone. Note that algorithms such as (5) or (6), or variants thereon, do not reconstruct information which has been totally lost in measurement; they cannot overcome the presence of a zero in H(p). However, they do provide a more reliable and more robust deconvolution than (4), especially where H(p) is small or uncertain. Both Van Clittert's approximation and the Richardson-Lucy approximation are well behaved such that they converge to a stationary point.

Although not limited to these two algorithms, the present solution preferably uses one or other of them. Note that these algorithms easily accommodate sampling functions which vary with position or time or some other parameter, which would be difficult or impossible in spectral methods such as (4). The solution is thus based on using the sampling function for the sensor which can be known a priori. Additionally, the method comprises steps: performing at least one iteration of an algorithm which approximates a deconvolution after a number of iterations, each iteration yielding a refined estimate of the deconvoluted function, and using the sensor measurement as the initial estimate for the deconvolution.

Since, in practice, the calculation is performed in the form of a matrix, the sampling function is now studied in the matrix form. This study concerns both the untransformed sampling function h and the integral-transformed sampling function H. The sampling function as a matrix H can be decomposed and expressed in the form of product of three matrices as:

H=USV^{T},

where V and U are matrices used in the decomposition and S is a diagonal matrix that has eigenvalues of the sampling function H in the diagonal. A number of decompositions will diagonalize S. Spectral decompositions are particularly informative diagonalizations, for which the columns of U are linearly independent and have unity norm and the columns of V are linearly independent and have unity norm. The columns of U and V contain the basis functions or spectral patterns of the decomposition. The diagonal elements of S then indicate the fidelity of the sensor in representing the spectral patterns in V using spectral patterns in U. For instance, the columns of both U and V could be sets of sine and cosine functions, in which case S would contain the gain of the sensor at each spatial frequency. For an ideal sensor, all of the diagonal elements of S are unity. In spectral representations of actual sensors, some elements of S are not unity, and some may be zero. Usually, some elements of S are near unity in magnitude, corresponding to spectral modes which are accurately represented in the measurement. If the sensor is poorly designed or poorly constructed or poorly maintained, some elements of S may significantly exceed unity. The SVD (Singular Value Decomposition) is a well-known spectral decomposition, which will be used here for illustrative purposes, but the arguments apply to any spectral decomposition. The SVD method is unique and optimal in numerous ways. For instance, if the dimension of H is n and the rank is r, the first r rows of U forms a basis for the range of H, while the last n-r columns of V forms a basis for the null space of H. With SVD method the columns of U and V matrices have unity 2-norms, and the diagonal elements of the matrix S are its singular values, being square roots of the eigenvalues of H*H, where H* is the complex conjugate matrix of the matrix H, ordered from largest to smallest. The diagonal eigenvaluematrix S can be expressed as:

$$S = [ \begin{matrix}{s}_{1} & 0 & 0 & 0 & 0 & 0 \\ 0 & {s}_{2} & 0 & 0 & 0 & 0 \\ 0 & 0 & ⋰ & 0 & 0 & 0 \\ 0 & 0 & 0 & {s}_{t} & 0 & 0 \\ 0 & 0 & 0 & 0 & ⋰ & 0 \\ 0 & 0 & 0 & 0 & 0 & 0\end{matrix} ] ,$$

where s₁-sₜ are the eigenvalues or singular values of the sampling function H. The inverse of the eigenvaluematrix S⁻¹ can be expressed as:

$${S}^{- 1} = [ \begin{matrix}1 / {s}_{1} & 0 & 0 & 0 & 0 & 0 \\ 0 & 1 / {s}_{2} & 0 & 0 & 0 & 0 \\ 0 & 0 & ⋰ & 0 & 0 & 0 \\ 0 & 0 & 0 & 1 / {s}_{t} & 0 & 0 \\ 0 & 0 & 0 & 0 & ⋰ & 0 \\ 0 & 0 & 0 & 0 & 0 & 0\end{matrix} ]$$

The inverse of the sampling function H⁻¹ is then expressed as:

H⁻¹=VS⁻¹U^{T}, (8)

which can be used in direct deconvolution as in Formula (4). In iterarive solutions, it is not necessary to invert the sampling function, or even to construct a spectral representation of it. The presented solution is approximately equivalent to a spectral method in which at least one of the non-zero and non-unity elements s₁ . . . sₜ of S or S⁻¹ is taken into account in the estimate of the sampling function H. If only the unity elements of S or S⁻¹ are taken into account, just the undistorted patterns are preserved in the measurement. By taking also at least one non-unity element into account, and compensating the corresponding measured pattern to emulate a sensor whose corresponding spectral gain would be unity, the accuracy of the sensor can be improved. Clearly, spectral modes for which the element of S is near zero cannot be compensated accurately, since all actual sensors introduce some noise into the measured patterns, and this noise is also amplified by compensation. In practice, some minimum magnitude for sensor gain for which compensation is worthwhile can be determined from knowledge of the sensor's noise characteristics. The presented solution is suitable to spectral methods, since it can accommodate position-dependent and speed-dependent kernels, and does not require spectral estimates.

The sampling function H can be made available and known by measurement, simulation, or theoretical analysis. The sampling function, which corresponds to the impulse response of the sensor, can be measured experimentally by feeding a signal corresponding to the Dirac's impulse δ to the sensor. FIG. 3 shows an example of the frequency response of a sensor. The vertical axis shows the value of the response, and the horizontal axis shows the frequency. In practice, the impulse can be implemented with a signal which is generated by a phenomenon taking place in a frequency zone 302 above the normal frequency response 300 of the sensor. For instance, in CD measurement, a thin wire can be conducted in front of the moisture sensor, the response of which is an impulse response. Similarly, an impulse can be approximated by a pinhole source of collimated or uncollimated light for optical sensors.

By using estimated sampling functions which correspond to the physical principles and operation of the actual sensor, it is possible to use this method with a variety of measurement devices. In particular, it can be applied to measurements made by (i) a sensor which traverses the full width of the sheet, (ii) an array of sensors which each traverse a portion of the sheet.

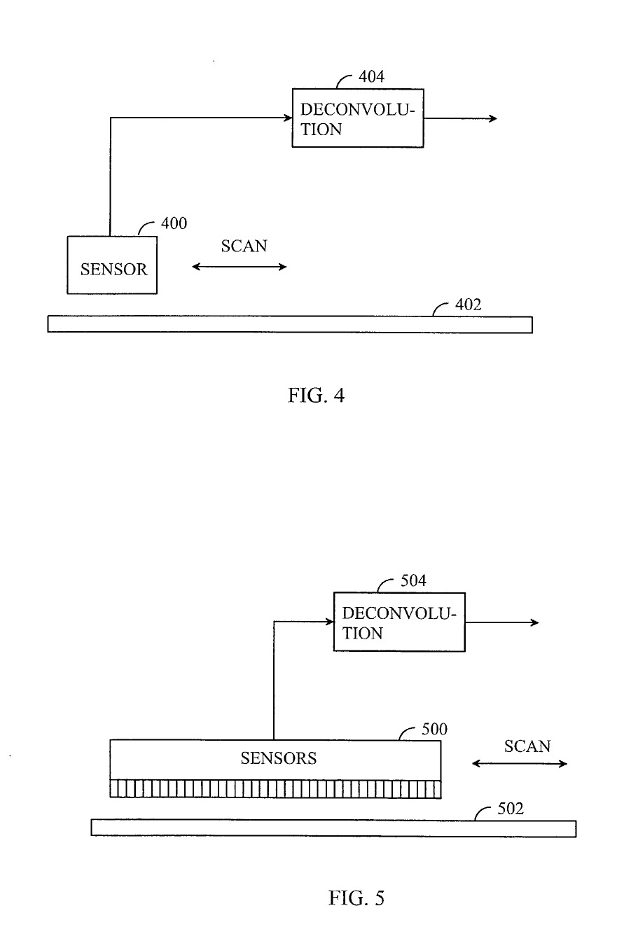

FIG. 4 shows a solution in which one sensor 400 scans over an object 402 to be measured. Thus, the scanning sensor 400 moves forwards and backwards at a desired scanning speed in the direction indicated by the arrow over the object 402 to be measured and measures at one or more points the moisture content, caliper, basis weight, ash content, carbonate content, gloss, brightness, smoothness, hardness or temperature of the object 402 to be measured. When one or more measurements have been performed, each measurement result is deconvoluted in means 404 with a known sampling function. By incorporating the scanning speed in conjunction with the sampling function of a sensor, it is possible to reconstruct the property measured by a scanning sensor with higher resolution than provided by the original sensor measurement (see Formula 1c). Furthermore, it is possible to adapt the estimation according to the current scanning speed in cases where the scanning speed is variable.

FIG. 5 shows a solution in which an array of sensors 500 scans over an object 502 to be measured, the object being a paper web, for example. Since the array of sensors 500 comprises at least two sensors, the scanning distance does not have to be as long as in the solution of FIG. 4. When the measurements have been performed, each measurement result is deconvoluted with a sampling function in means 504. Thus, as is shown in Formula (1b), each sensor may have a sampling function of its own, which is dependent on the location of the sensor in the array of sensors, the sampling function being used for deconvoluting the measurement result of the sensor.

The sampling function can also be dependent on aspects other than the location of the sensor. Some sheet properties are not determined by measurements from a single sensor or an array of similar sensors, but are calculated using measurements from a plurality of sensors that measure different properties. For example, the dry mass of a sheet can be calculated by subtracting its water mass from its total mass. In general, different sensors using different physical principles or having different physical dimensions can have different sampling functions. Thus, it is advantageous to deconvolute sensor measurements before computing another property using measurements from plurality of sensors. In accordance with the example, the measurement of the moisture content and the measurement of the total mass are deconvoluted separately, and the dry mass is formed on the basis of the deconvoluted measurement results. Similar considerations apply whenever a property must be estimated from measurements made using different sensors, especially computation of mass fractions or mass ratios of individual constituents such as clay or ash or carbonate in a paper sheet.

Deconvolution can be preferably performed in such a way that the accuracies of the measurements can be made such that they correspond to each other. Thus, both measurements have, after suitable deconvolution, essentially the same spectral content. The deconvoluted measurements have essentially the same accuracy at all frequencies or scales for which they were computed. Since the sampling function is defined on the basis of measurement, simulation or theoretical derivation or analysis, the sampling function can be taken into account at a desired accuracy in the deconvolution. In a matrix-form spectral representation, for instance, it is enough that at least one of the elements s₁ . . . sₜ of S or S⁻¹, which is neither zero nor unity, is taken into account in forming the estimate of the sampling function H. The coarser the estimate of the sampling function in the deconvolution, the simpler the deconvolution becomes and the less calculations are required. Thus, the calculation also becomes more rapid. One advantageous feature of the presented solution is, therefore, that the deconvolution can be calculated in a desired manner and at a desired accuracy.

By using the known sampling function of a sensor, it is possible to reconstruct the property measured by the sensor with higher resolution than provided by the original sensor measurement. This is especially true when the measurement is oversampled, i.e., when the spatial interval between measurements is less than the effective width of the sampling function. When a measurement is oversampled, it invariably has some spectral modes which are attenuated (element of S with magnitude less than unity), and usually some modes which are essentially unmeasured (element of S with magnitude zero or near zero). These modes are incompletely represented in or absent from the sensor measurement.

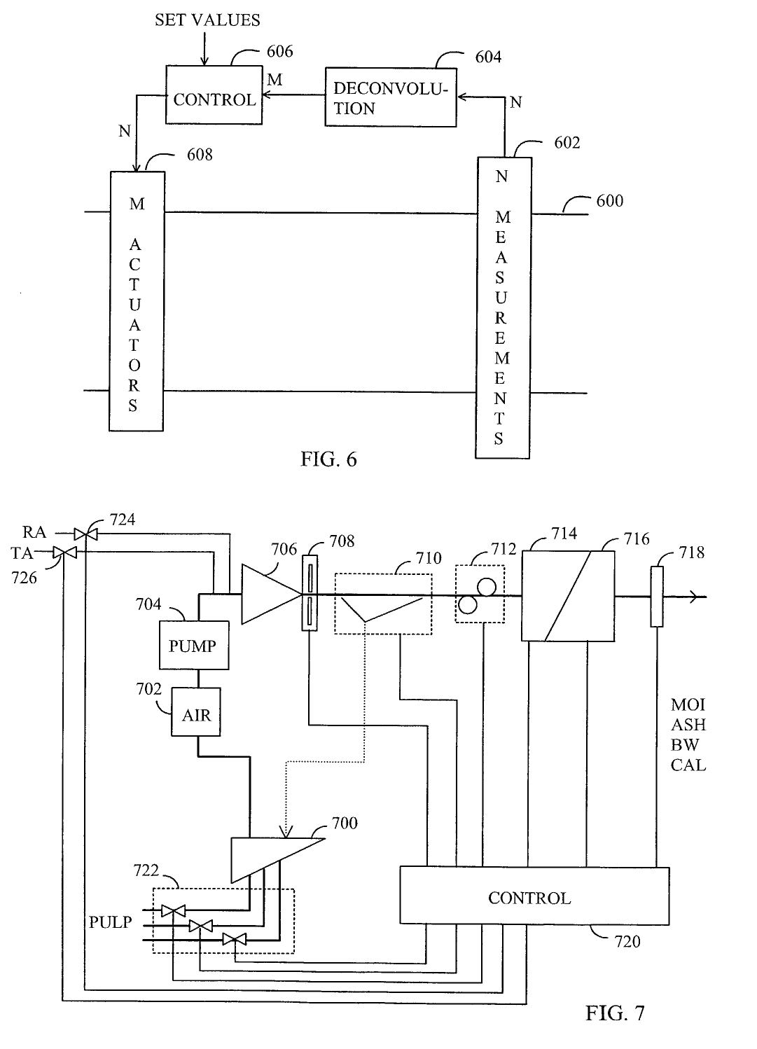

Let us still briefly study an application of CD measurement with reference to FIG. 6. The CD measurements have an important role in any sheet production control and particularly in the control of the paper or cardboard production. Sheet properties are commonly measured by sensors 602 at a plurality of locations (N measurements) across the sheet 600, where such plurality usually exceeds the plurality of actuators 608 (M actuators). The number of measurements N is often N≈3M. These N measurements form a measured profile. The measured sheet properties generally exhibit different deviations from desired values across the machine, and the purpose of regulation is to cause the measurements to approach the desired values, which form a desired profile. After the CD measurements of the sheet 600 are made by the N sensors 602 the results are deconvoluted by the presented method in the deconvolution unit 604, which can be a separate block or a part of control means 606. The deconvoluted measurement results are compared with the set values and an error profile is formed to indicate the difference between the measurement results and the set values in the means for controlling 606, which is without the deconvolution-performing part 604 a control unit according to the prior art. A process which is in a state matching the set values is known to produce a sheet of a desired quality and, thus, the process should be kept in a state matching the set values as exactly as possible. By means of the error profile and a nominal process model, a control unit 606 gives a control command to M actuators 608, which alter the process according to the command. For example, nip pressure, steam quantity or other heat applied to the sheet during the process can be used as actuators. The measurement variables are altered or maintained by means of the actuators 608 to maintain good quality of the paper being made.

Since the measurement performed by the sensors 602 can be made more accurate by deconvolution, the control of the actuators 608 can be performed more accurately, and the whole process can be controlled in an improved manner, so that also the quality of the sheet is improved.

Finally, with reference to FIG. 7, let us study a paper machine, which is one important object of application of the present solution. FIG. 7 shows a general structure of a paper machine. One or more types of stock is fed into the paper machine through a wire pit silo 700 which is usually preceded by a blending chest and machine chest (not shown in FIG. 7). The stock is metered into a short circulation controlled by a basis weight control or a grade change program. The blending chest and the machine chest can also be replaced by a separate mixing reactor (not shown in FIG. 1) and stock metering is controlled by feeding partial stocks separately by means of valves or some other type of flow control means 722. In the wire pit silo 700, water is mixed into the stock to achieve the required consistency for the short circulation (dashed line from a former 710 to the wire pit silo 700). Sand (centrifugal cleaners), air (deculator) and other coarse material (pressure filter) are removed from the thus obtained stock using cleaning devices 702 and the stock is pumped by a pump 704 to the headbox 706. Before the headbox 706, a filler TA, such as kaolin, calcium carbonate, talc, chalk, titanium dioxide, diatomite, and a retention aid RA, such as inorganic, inartificial organic or synthetic water-soluble polymers, are added to the stock using the valves 724-726 in a desired manner. The purpose of the filler is to improve the formation, surface properties, opacity, lightness and printing quality as well as to reduce the manufacturing costs. Retention aids RA, for their part, improve the retention of the fines and fillers while speeding up dewatering in a manner known per se. From the headbox 706, the stock is fed through the slice opening 708 of the headbox to the former 710 which is a fourdrinier in slow paper machines and a gap former in fast paper machines. In the former 710, water drains out of the web, and ash, fines and fibers are led to the short circulation. In the former 710, the stock is fed as a fiber web onto a wire, and the web is initially dried and pressed in a press 712. The fiber web is primarily dried in dryers 714 and 716. In addition, there is usually at least one measuring beam 718 with at least one sensor for performing the CD measurements that are deconvoluted and refined with the present solution, for instance the moisture MOI of the fiber web, the caliper CAL and the basis weight BW of the paper being made. The controller 720, which in this figure comprises the deconvoluting unit, utilizes the measuring beam 718 to monitor the control measures, quality and/or grade change. The controller 720 preferably also measures the properties of the paper web elsewhere (e.g. at the same locations where controls are made). The controller 720 is part of the control arrangement based on automatic data processing. The paper machine, which in this application refers to both paper and board machines, also comprises a reel and size presses or a calender, for instance, but these parts are not shown in FIG. 7. The general operation of a paper machine is known per se to a person skilled in the art and need, therefore, not be presented in more detail in this context.

Although the invention is described above with reference to an example shown in the attached drawings, it is apparent that the invention is not restricted to it, but can vary in many ways within the inventive idea disclosed in the attached claims.

What is claimed is:

1. A method for performing a measurement of a continuous sheet, the method comprising:
performing at least one measurement of the sheet in which an estimate of the sampling function of the measurement is available;
performing the deconvolution of the at least one measurement with the estimate of the sampling function using at least one iteration of an algorithm which corresponds to the deconvolution.

2. A method for performing a CD-measurement of a continuous sheet, the method comprising:
scanning the sheet;
performing during scanning at least one measurement of the sheet in which an estimate of the sampling function of the measurement is available;
performing the deconvolution of the at least one measurement with the estimate of the sampling function using at least one iteration of an algorithm which corresponds to the deconvolution.

3. A method for controlling production of a continuous sheet, the method comprising:
scanning the sheet across the production line;
performing during scanning at least one measurement of the sheet in which an estimate of the sampling function of the measurement is available;
performing the deconvolution of the at least one measurement with the estimate of the sampling function using at least one iteration of an algorithm which corresponds to the deconvolution; and
controlling the production of the continuous sheet using the at least one deconvoluted measurement.

4. The method of claim 1, wherein the sampling function is made available by measurement, simulation or theoretical analysis.

5. The method of claim 1, wherein the measurement comprises a CD-measurement of moisture content, caliper or basis weight in a paper making process.

6. The method of claim 1, performing the deconvolution using at least one iteration of an iterative algorithm which approximates the deconvolution.

7. The method of claim 6, approximating the deconvolution with at least two iterations, each iteration yielding a refined estimate of the deconvoluted function; and
using the measurements as the initial estimate for the deconvolution.

8. The method of claim 1, scanning the sheet;
performing a set of measurements during scanning the sheet; and
canceling the effect of the scanning speed by deconvolution of each of the measurements with the estimate of sampling function in which the scanning speed is incorporated.

9. The method of claim 1, oversampling the measurement so that the interval of samples is less than the effective width of the sampling function.

10. The method of claim 1, performing the measurement using one sensor and performing scanning of the sheet by traversing the sensor over the sheet.

11. The method of claim 1, performing a set of measurements using an array of sensors and performing the scanning of the sheet by traversing the array of the sensors over the sheet.

12. The method of claim 1, comparing the at least one measurement f to convolution g*h of estimated true measurement g and the sampling function h in the iteration of the deconvolution; and
changing the estimated true measurement g on the basis of the comparision in each iteration step.

13. The method of claim 1, comparing the measurement f to convolution g*h of estimated true measurement g and the sampling function h by forming a difference f−g*h or ratio f/(g*h); and
changing the estimated true measurement g on the basis of the comparision.

14. The method of claim 13, weighting the comparation by weight λ in difference λ(f−g*h) or ratio λf/(g*h).

15. The method of claim 14, giving value of the weight λ as a function of the approximation of each iteration of the true measurement g in each iteration.

16. The method of claim 1, approximating the deconvolution using a Van Clittert's approximation k+1 from approximation k by:
$${g}^{( k + 1 )} ( x ) = {g}^{k} ( x ) + λ ( f ( x ) - {∮}_{W} {g}^{k} ( x + u ) h ( u ) ⅆ u ) ,$$
where λ is a weight and the measurement f(x) is taken as the initial approximation, g⁰(x)=f(x).

17. The method of claim 1, approximating the deconvolution using a Richardson-Lucy approximation approximation k+1 from approximation
$${g}^{( k + 1 )} ( x ) = {g}^{k} ( x ) ( 1 + λ ( \frac{f ( x )}{{∮}_{W} {g}^{k} ( x + u ) h ( u ) ⅆ u} - 1 ) )$$
where λ is a weight and the measurement f(x) is taken as the initial approximation, g⁰(x)=f(x).

18. The method of claim 1, when determining a new property as a function of at least two of the measured properties, deconvoluting the measured properties before the determination of the new property.

19. An arrangement for performing a measurement of a continuous sheet, the arrangement comprising:
at least one sensor for performing at least one measurement of the sheet, an estimate of the sampling function of the sensor being available;
means for performing deconvolution using at least one iteration of an algorithm which corresponds to the deconvolution, and the means are arranged to perform the deconvolution of the at least one measurement with the estimate of the sampling function.

20. An arrangement for performing a CD-measurement of a continuous sheet, the arrangement comprising:
at least one sensor for performing at least one measurement of the sheet, an estimate of the sampling function of the sensor being available;
means for performing deconvolution using at least one iteration of an algorithm which corresponds to the deconvolution, and the means are arranged to perform the deconvolution of the at least one measurement with the estimate of the sampling function.

21. An arrangement for controlling production of a continuous sheet, the arrangement comprising:
at least one sensor for performing at least one measurement of the sheet, an estimate of the sampling function of the sensor being available;
means for performing deconvolution using at least one iteration of an algorithm which corresponds to the deconvolution, the means being arranged to perform the deconvolution of the at least one measurement with the estimate of the sampling function; and
means for controlling the production of the continuous sheet using the at least one deconvoluted measurement.

22. The arrangement of claim 19, wherein the sampling function is made available by measuring, simulating or theoretically deriving.

23. The arrangement of claim 19, wherein the arrangement is arranged to perform a CD-measurement of moisture content, caliper, basis weight, ash content, carbonate content, gloss, brightness, smoothness, hardness or temperature in a paper making process.

24. The arrangement of claim 19, wherein the means for performing deconvolution are arranged to perform at least one iteration of an iterative algorithm which approximates the deconvolution.

25. The arrangement of claim 19, wherein the means for performing deconvolution are arranged to approximate the deconvolution with at least two iterations, each iteration yielding a refined estimate of the deconvoluted function; and to use the measurements as the initial estimate for the deconvolution.

26. The arrangement of claim 19, wherein the sensor is arranged to scan the sheet;
the arrangement is arranged to perform a set of measurements during scanning the sheet; and
the means for performing deconvolution are arranged to perform deconvolution of each of the measurements with the estimate of the sampling function in which the scanning speed of the at least one sensor is incorporated.

27. The arrangement of claim 19, wherein the sensor is arranged to oversample the measurement so that the interval of samples is less than the effective width of the sampling function.

28. The arrangement of claim 19, wherein the arrangement comprises one sensor and the arrangement is arranged to perform scanning by traversing the sensor over the sheet.

29. The arrangement of claim 19, wherein the arrangement comprises an array of sensors and the arrangement is arranged to perform scanning by traversing the array of the sensors over the sheet.

30. The arrangement of claim 19, wherein the means for performing deconvolution are arranged to compare the at least one measurement f to convolution g*h of estimated true measurement g and the sampling function h in the iteration of the deconvolution; and to change the estimated true measurement g on the basis of the comparison in each iteration step.

31. The arrangement of claim 19, wherein the means for performing deconvolution are arranged to compare the measurement f to convolution g*h of estimated true measurement g and the sampling function h by forming a difference f−g*h or ratio f/(g*h); and to change the estimated true measurement g on the basis of the comparison in each iteration step.

32. The arrangement of claim 31, wherein the means for performing deconvolution are arranged to weight the comparation by weight λ in difference λ(f−g*h) or ratio λf/(g*h).

33. The arrangement of claim 32, wherein the value of the weight λ is a function of the approximation of the true measurement g in each iteration.

34. The arrangement of claim 19, wherein the means for performing deconvolution are arranged to approximate the deconvolution using a Van Clittert's approximation k+1 from approximation k by:
$${g}^{( k + 1 )} ( x ) = {g}^{k} ( x ) + λ ( f ( x ) - {∮}_{W} {g}^{k} ( x + u ) h ( u ) ⅆ u ) ,$$
where λ is a weight and the measurement f(x) is taken as the initial approximation, g⁰(x)=f(x).

35. The arrangement of claim 19, wherein the means for performing deconvolution are arranged to approximate the deconvolution using a Richardson-Lucy approximation k+1 from approximation k by:
$${g}^{( k + 1 )} ( x ) = {g}^{k} ( x ) ( 1 + λ ( \frac{f ( x )}{{∮}_{W} {g}^{k} ( x + u ) h ( u ) ⅆ u} - 1 ) )$$
where λ is a weight and the measurement f(x) is taken as the initial approximation, g⁰(x)=f(x).

36. The arrangement of claim 19, wherein the arrangement is arranged to determine a new property using at least two of the measured properties, and the means for performing deconvolution are arranged to deconvolute the measured properties before the determination of the new property.
